(19) United States
(12) Patent Application Publication
(10) Pub. No.: US 2012/0262499 A1
(43) Pub. Date: Oct. 18, 2012

(54) CONTROL METHOD FOR ELECTRO-OPTICAL DEVICE, CONTROL DEVICE FOR ELECTRO-OPTICAL DEVICE, ELECTRO-OPTICAL DEVICE AND ELECTRONIC APPARATUS

(75) Inventor: Yuko Komatsu, Suwa-shi (JP)

(73) Assignee: Seiko Epson Corporation, Tokyo (JP)

(21) Appl. No.: 13/442,072

(22) Filed: Apr. 9, 2012

(30) Foreign Application Priority Data
Apr. 15, 2011 (JP) 2011-090929

(51) Int. Cl. G09G 3/34; G09G 5/10

(52) U.S. Cl. 345/690; 345/85

(57) ABSTRACT

A control method for controlling an electro-optical device is disclosed. When an image in a display section is rewritten from a first image to a second image, a drive section is controlled such that voltage corresponding to the first gray level is applied to a first pixel whose gray level to be displayed changes from a second gray level to a first gray level, voltage corresponding to the first gray level is applied to a second pixel having two or more sides adjacent to pixels displayed in the second gray level when the first image is displayed, among pixels whose gray level to be displayed does not change and remains in the first gray level, and voltage is not applied to a third pixel, other than the second pixel, among the pixels whose gray level to be displayed does not change and remains in the first gray level.

### BACKGROUND

1. Technical Field

The present invention relates to methods for controlling an electro-optical device such as for example an electrophoretic display device, devices for controlling an electro-optical device, electro-optical devices and electronic apparatuses.

2. Related Art

An electrophoretic display device is one example of the electro-optical device devices described above. The electrophoretic display device displays images at a display section by applying voltages between pixel electrodes and a counter electrode disposed opposite each other with electrophoretic elements containing electrophoretic particles sandwiched therebetween, thereby migrating electrophoretic particles, such as, black particles and white particles (see, for example, Japanese Laid-open Patent Applications 2010-113281 (Patent Document 1), 2010-113282 (Patent Document 2), and 2010-211033 (Patent Document 3)). When an image being displayed at the display section is rewritten, and only a portion of the image is changed, the electrophoretic display device described above may use a driving method of partially rewriting an image (hereafter suitably referred to as a “partial rewriting drive”) by applying voltage across the pixel electrodes and the counter electrode only at pixels corresponding to the portion that is changed. In the electrophoretic display device using the partial rewriting drive, it has been known that a boundary portion between a black image section displayed in black and a white image section displayed in white in the image displayed at the display device may appear blurry. In other words, the contour portion of the black image section may be displayed as if it spreads (or bulges) into the white image section. When such a blur occurs at the boundary portion, and when the image displayed at the display section is rewritten entirely to an all-white image by applying voltage only to the pixels corresponding to the black image section, the blur at the boundary portion may remain as an afterimage, in other words, an afterimage may occur along the contour portion of the black image section displayed. It is noted that, hereafter, the phenomenon in which an afterimage occurs along such contour portions as described above, or the afterimage occurring along such contour portions may be suitably called a “contour afterimage.” For example, Patent Documents 1 through 3 describe a technology to erase a contour afterimage, when an image displayed at a display section is rewritten to an all-white image by the partial rewriting drive (in other words, a black image section of the image is erased), by the application of voltage to pixels corresponding to the black image section as well as pixels displaying white and arranged adjacent to the contour portion of the black image section.

However, according to the technology described in, for example, the aforementioned Patent Documents 1 through 3, voltage for erasing a contour afterimage is applied uniformly to pixels displaying white and arranged adjacent to pixels corresponding to a contour portion of a black image section. Therefore there is a possibility that the voltage may be applied to pixels corresponding to portions that do not display the contour afterimage in the display section. Therefore the technology described above entails a technical problem in that the DC balance (the balance between the time of voltage application between the pixel electrodes and the counter electrode which sets the potential on the pixel electrode side higher than the potential on the counter electrode side and the time of voltage application between the pixel electrodes and the counter electrode which sets the potential on the pixel electrode side lower than the potential on the counter electrode side) at the display section may locally be destroyed.

### SUMMARY

In accordance with an advantage of some aspects of the invention, there are provided a control method for controlling an electro-optical device, a control device for controlling an electro-optical device, and an electro-optical device and an electronic apparatus, which can reduce occurrence of contour afterimages while suppressing occurrence of destruction of the DC balance.

A first aspect of the invention pertains to a control method for controlling an electro-optical device equipped with a display section formed from a plurality of pixels each having an electro-optical substance between a pixel electrode and a counter electrode disposed opposite each other, and a drive section that applies voltage across the pixel electrode and the counter electrode of each of the plurality of pixels. When an image displayed at the display section is rewritten from a first image displayed in a first gray level and a second gray level different from the first gray level to a second image displayed in the first gray level, the drive section is controlled such that voltage corresponding to the first gray level is applied between the pixel electrode and the counter electrode of a first pixel whose gray level changes from the second gray level to the first gray level among the plurality of pixels, voltage corresponding to the first gray level is applied between the pixel electrode and the counter electrode of a second pixel having two or more sides adjacent to pixels displayed in the second gray level when the first image is displayed at the display section, among pixels whose gray level to be displayed does not change and remains in the first gray level among the plurality of pixels, and voltage is not applied between the pixel electrode and the counter electrode of a third pixel other than the second pixel among the pixels whose gray level to be displayed does not change and remains in the first gray level among the plurality of pixels.

The electro-optical device controlled by the control method for controlling an electro-optical device according to the first aspect of the invention may be, for example, an electrophoretic display device using an active matrix drive system, and may be equipped with a display section formed from a plurality of pixels arranged, for example, in a matrix configuration, and a drive section that applies voltage according to, for example, image data across a pixel electrode and a counter electrode of each of the pixels. The drive section applies voltage according to image data across the pixel electrode and the counter electrode of each of the plurality of pixels, whereby an image according to, for example, the image data is displayed at the display section.

According to the control method for controlling an electro-optical device in accordance with the first aspect of the invention, when an image displayed at the display section is rewritten from a first image (for example, a two-gray level image in black and white) displayed in the first gray level (for example, white) and the second gray level (for example, black) to a second image (for example, an all-white image) displayed in the first gray level (for example, white), in other words, when a portion displayed in the second gray level in the first image displayed at the display section is erased, the drive section is controlled in the following manner.

Specifically, the drive section is controlled such that voltage corresponding to the first gray level (for example, voltage that sets the potential on the pixel electrode side lower than the potential on the counter electrode side) is applied between the pixel electrode and the counter electrode of a first pixel whose gray level to be displayed changes from the second gray level (for example, black) to the first gray level (for example, white), voltage corresponding to the first gray level is applied between the pixel electrode and the counter electrode of a second pixel having two or more sides adjacent to pixels displayed in the second gray level (for example, black) when the first image is displayed at the display section, among pixels whose gray level to be displayed does not change and remains in the first gray level (for example, white) among the plurality of pixels, and voltage is not applied between the pixel electrode and the counter electrode of a third pixel other than the second pixel among the pixels whose gray level to be displayed does not change and remains in the first gray level (for example, white) among the plurality of pixels. It is noted that the invention is typically applicable to pixels each having a quadrilateral plane configuration having four sides. However, the invention is also applicable to pixels each having a polygonal plane configuration, such as, for example, a triangle plane configuration, a hexagonal plane configuration, and the like.

In accordance with the first aspect of the invention, a first image may be displayed at the display section, typically, by the control of the drive section in a manner that, when an image (for example, an all-white image) formed from only the first gray level (for example, white) is displayed at the display section, voltage corresponding to the second gray level (for example, voltage that sets the potential on the pixel electrode side higher than the potential on the counter electrode side) is applied between the pixel electrode and the counter electrode of a pixel forming a part of the plurality of pixels (for example, a pixel corresponding to a section to be displayed in the second gray level (for example, black) in the first image), and voltage is not applied between the pixel electrode and the counter electrode of a pixel other than the pixel forming the part of the plurality of pixels. According to the research conducted by the inventor of the present application, when the first image is displayed at the display section as a result of the drive section being controlled in a manner described above, the following tendency is observed. Among pixels that are to display the first gray level (in other words, pixels at which voltage is not applied), a pixel having two or more sides adjacent to pixels that are to display the second gray level (i.e., pixels at which voltage corresponding to the second gray level is applied) tends to display a gray level different from the first gray level because of the influence of the voltage corresponding to the second gray level applied to the adjacent pixels; and among pixels that are to display the first gray level, a pixel having only one side or no side adjacent to a pixel that is to display the second gray level has a tendency to display securely the first gray level. When a first image is displayed at the display section, if a gray level different from the first gray level is displayed at pixels that are to display the first gray level, as described above, the following problem may occur. If the first image is rewritten to a second image by controlling the drive section in a manner that voltage corresponding to the second gray level is applied only to pixels that display the first gray level among the plurality of pixels, and voltage is not applied to other pixels, a contour afterimage would likely be generated at a pixel having two or more sides adjacent to pixels that display the second gray level, among pixels that are supposed to display the first gray level when the first image is displayed at the display section.

Therefore, in accordance with the first aspect of the invention in particular, as described above, when an image displayed at the display section is rewritten from a first image to a second image, the drive section is controlled such that voltage corresponding to the first gray level is applied between the pixel electrode and the counter electrode of the second pixel having at two or more sides adjacent to pixels displayed in the second gray level (for example, black) when the first image is displayed at the display section, among pixels whose gray level to be displayed does not change and remains in the first gray level (for example, white) among the plurality of pixels. Therefore, it is possible to reduce the occurrence of contour afterimages at the second pixels that have a tendency to generate contour afterimages. As a result, high quality image can be displayed at the display section.

Furthermore, in accordance with the first aspect of the invention, voltage is not applied between the pixel electrode and the counter electrode of the third pixel that tends to generate almost or practically no contour afterimage. Therefore, destruction of the DC balance can be suppressed better, compared to a case where the drive section is controlled in a manner that voltage corresponding to the first gray level (for example, white) is applied between the pixel electrodes and the counter electrodes of all pixels having sides adjacent to pixels displayed in the second gray level (for example, black) when the first image is displayed at the display section, among pixels whose gray level to be displayed does not change and remains in the first gray level (for example, white) among the plurality of pixels. Accordingly, the reliability of the electro-optical device can be improved.

As described above, according to the control method for an electro-optical device in accordance with the first aspect of the invention, while destruction of the DC balance can be suppressed, generation of contour afterimages can be reduced. As a result, high quality images can be displayed at the display section, and the reliability of the electro-optical device can be improved.

A second aspect of the invention pertains to a control method for controlling an electro-optical device. In accordance with the second aspect of the invention, the electro-optical device equipped with a display section formed from a plurality of pixels each having an electro-optical substance between a pixel electrode and a counter electrode disposed opposite each other, and a drive section that applies voltage across the pixel electrode and the counter electrode of each of the plurality of pixels is controlled by the control method as follows. When an image displayed at the display section is rewritten from a first image displayed in a first gray level and a second gray level different from the first gray level to a second image displayed in the first gray level and the second gray level different from those of the first image, the drive section is controlled such that voltage corresponding to the first gray level is applied between the pixel electrode and the counter electrode of a first pixel, among the plurality of pixels, whose gray level to be displayed changes from the second gray level to the first gray level, voltage corresponding to the first gray level is applied between the pixel electrode and the counter electrode of a second pixel having two or more sides adjacent to pixels displayed in the second gray level when the first image is displayed at the display section, among pixels whose gray level to be displayed does not change and remains in the first gray level among the plurality of pixels, voltage is not applied between the pixel electrode and the counter electrode of a third pixel other than the second pixel among the pixels whose gray level to be displayed does not change and remains in the first gray level among the plurality of pixels, voltage corresponding to the second gray level is applied between the pixel electrode and the counter electrode of a fourth pixel, among the plurality of pixels, whose gray level to be displayed changes from the first gray level to the second gray level, and voltage is not applied between the pixel electrode and the counter electrode of a fifth pixel whose gray level to be displayed does not change and remains in the second gray level among the plurality of pixels.

An electro-optical device controlled by the control method for controlling an electro-optical device in accordance with the second aspect of the invention may be, for example, an electrophoretic display device using an active matrix drive system.

According to the control method for controlling an electro-optical device in accordance with the second aspect of the invention, when an image displayed at the display section is rewritten from a first image (for example, a two-gray level image in black and white) displayed in a first gray level (for example, white) and a second gray level (for example, black) different from the first gray level to a second image (for example, a two-gray level image in black and white) displayed in the first gray level and the second gray level different from the first image, the drive section is controlled such that voltage corresponding to the first gray level (for example, voltage that sets the potential on the pixel electrode lower than the potential on the counter electrode) is applied between the pixel electrode and the counter electrode of a first pixel whose gray level to be displayed changes from the second gray level (for example, black) to the first gray level (for example, white), voltage corresponding to the first gray level is applied between the pixel electrode and the counter electrode of a second pixel having two or more sides adjacent to pixels displayed in the second gray level (for example, black) when the first image is displayed at the display section, among pixels whose gray level to be displayed does not change and remains in the first gray level among the plurality of pixels, voltage is not applied between the pixel electrode and the counter electrode of a third pixel other than the second pixel among the pixels whose gray level to be displayed does not change and remains in the first gray level (for example, white) among the plurality of pixels, voltage corresponding to the second gray level is applied between the pixel electrode and the counter electrode of a fourth pixel, among the plurality of pixels, whose gray level to be displayed changes from the first gray level (for example, white) to the second gray level (for example, black), and voltage is not applied between the pixel electrode and the counter electrode of a fifth pixel whose gray level to be displayed does not change and remains in the second gray level (for example, black) among the plurality of pixels.

Therefore, in a manner similar to the control method for an electro-optical device in accordance with the first aspect of the invention, while destruction of the DC balance can be suppressed, generation of contour afterimages at the second pixels that have a tendency to generate contour afterimages can be reduced. As a result, high quality images can be displayed at the display section, and the reliability of the electro-optical device can be improved. Moreover, an image displayed at the display section can be directly rewritten from a first image to a second image, without displaying an image displayed only in, for example, the first gray level (for example, an all-white image) at the display section.

A third aspect of the invention pertains to a control device for controlling an electro-optical device equipped with a display section formed from a plurality of pixels each having an electro-optical substance between a pixel electrode and a counter electrode disposed opposite each other, and a drive section that applies voltage across the pixel electrode and the counter electrode of each of the plurality of pixels. When an image displayed at the display section is rewritten from a first image displayed in a first gray level and a second gray level different from the first gray level to a second image displayed in the first gray level, the control device in accordance with the third aspect of the invention controls the drive section such that voltage corresponding to the first gray level is applied between the pixel electrode and the counter electrode of a first pixel, among the plurality of pixels, whose gray level to be displayed changes from the second gray level to the first gray level, voltage corresponding to the first gray level is applied between the pixel electrode and the counter electrode of a second pixel having two or more sides adjacent to pixels displayed in the second gray level when the first image is displayed at the display section, among pixels whose gray level to be displayed does not change and remains in the first gray level among the plurality of pixels, and voltage is not applied between the pixel electrode and the counter electrode of a third pixel other than the second pixel among the pixels whose gray level to be displayed does not change and remains in the first gray level among the plurality of pixels.

According to the control device for an electro-optical device in accordance with the third aspect of the invention, in a manner similar to the control method for an electro-optical device in accordance with the first aspect of the invention, while destruction of the DC balance can be suppressed in the electro-optical device, generation of contour afterimages can be reduced. As a result, high quality images can be displayed at the display section, and the reliability of the electro-optical device can be improved.

A fourth aspect of the invention pertains to a control device for controlling an electro-optical device equipped with a display section formed from a plurality of pixels each having an electro-optical substance between a pixel electrode and a counter electrode disposed opposite each other, and a drive section that applies voltage across the pixel electrode and the counter electrode of each of the plurality of pixels. When an image displayed at the display section is rewritten from a first image displayed in a first gray level and a second gray level different from the first gray level to a second image displayed in the first gray level and the second gray level different from the first image, the control device in accordance with the fourth aspect of the invention controls the drive section such that voltage corresponding to the first gray level is applied between the pixel electrode and the counter electrode of a first pixel, among the plurality of pixels, whose gray level to be displayed changes from the second gray level to the first gray level, voltage corresponding to the first gray level is applied between the pixel electrode and the counter electrode of a second pixel having two or more sides adjacent to pixels displayed in the second gray level when the first image is displayed at the display section, among pixels whose gray level to be displayed does not change and remains in the first gray level among the plurality of pixels, voltage is not applied between the pixel electrode and the counter electrode of a third pixel other than the second pixel among the pixels whose gray level to be displayed does not change and remains in the first gray level among the plurality of pixels, voltage corresponding to the second gray level is applied between the pixel electrode and the counter electrode of a fourth pixel, among the plurality of pixels, whose gray level to be displayed changes from the first gray level to the second gray level, and voltage is not applied between the pixel electrode and the counter electrode of a fifth pixel whose gray level to be displayed does not change and remains in the second gray level among the plurality of pixels.

Therefore, according to the control device for an electro-optical device in accordance with the fourth aspect of the invention, in a manner similar to the control method for an electro-optical device in accordance with the second aspect of the invention, while destruction of the DC balance can be suppressed, generation of contour afterimages can be reduced. As a result, high quality images can be displayed at the display section, and the reliability of the electro-optical device can be improved. Moreover, an image displayed at the display section can be directly rewritten from a first image to a second image, without displaying an image displayed only in, for example, the first gray level (for example, an all-white image) at the display section.

In accordance with another aspect of the invention, an electro-optical device is equipped with the control device for an electro-optical device according to the third aspect or the forth aspect of the invention.

As the electro-optical device in accordance with an aspect of the invention is equipped with the control device for an electro-optical device according to the third aspect or the forth aspect of the invention, while destruction of the DC balance can be suppressed, generation of contour afterimages can be reduced. As a result, high quality images can be displayed at the display section, and the reliability of the electro-optical device can be improved.

In accordance with another aspect of the invention, an electronic apparatus is equipped with the electro-optical device described above. Accordingly, various kinds of electronic apparatuses, such as, for example, wrist watches, electronic paper, electronic notebooks, portable phones, portable audio equipment and the like that are capable of displaying high quality images can be realized.

Effects and other advantages of the invention will become apparent by embodiments of the invention described below.

### BRIEF DESCRIPTION OF THE DRAWINGS

FIG. 1 is a block diagram showing the overall configuration of an electrophoretic display device in accordance with a first embodiment of the invention.

FIG. 2 is a diagram of an equivalent circuit of the electrical configuration of pixels of the electrophoretic display device in accordance with the first embodiment.

FIG. 3 is a cross-sectional view in part of a display section of the electrophoretic display device in accordance with the first embodiment.

FIG. 4 shows an example of images that are sequentially displayed on a display section in a plan view.

FIG. 5 is a conceptual figure showing voltages applied to pixels when an image Pw is rewritten to an image P1.

FIG. 6 is a plan view showing an example of blurry portions that can be generated when the image Pw is rewritten to the image P1.

FIG. 7 is a conceptual figure showing voltages to be applied to pixels when the image P1 is rewritten to an image Pw.

FIG. 8 shows another example of images that are sequentially displayed on a display section in a plan view.

FIG. 9 is a conceptual figure showing voltages applied to pixels when an image Pb is rewritten to an image P1.

FIG. 10 is a plan view showing an example of blurry portions that can be generated when the image Pb is rewritten to the image P1.

FIG. 11 is a conceptual figure showing voltages to be applied to pixels when the image P1 is rewritten to an image Pb.

FIG. 12 shows another example of images that are sequentially displayed on a display section in a plan view.

FIG. 13 is a conceptual figure showing voltages applied to pixels when an image Pw is rewritten to an image P2.

FIG. 14 is a plan view showing an example of blurry portions that can be generated when the image Pw is rewritten to the image P2.

FIG. 15 is a conceptual figure showing voltages to be applied to pixels when the image P2 is rewritten to an image P3.

FIG. 16 is a perspective view showing the configuration of an electronic paper that is an example of an electronic apparatus to which the electro-optical device is applied.

FIG. 17 is a perspective view showing the configuration of an electronic notebook that is an example of an electronic apparatus to which the electro-optical device is applied.

### DESCRIPTION OF EXEMPLARY EMBODIMENTS

Exemplary embodiments of the invention will be described below with reference to the accompanying drawings. In the following embodiments, an electrophoretic display device which is an example of an electro-optical device in accordance with a preferred embodiment of the invention will be described.

### First Embodiment

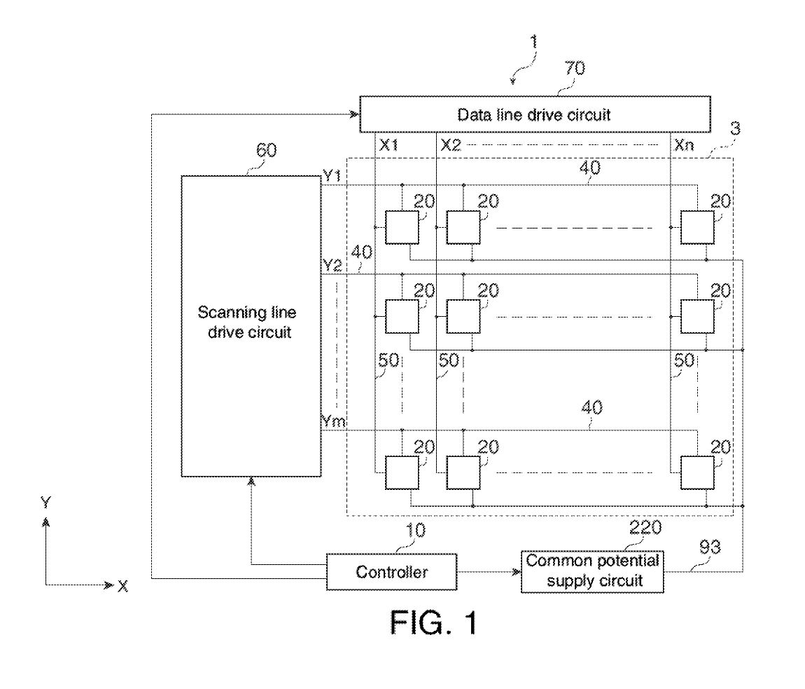

An electrophoretic display device in accordance with a first embodiment of the invention will be described with reference to FIGS. 1 through 7.

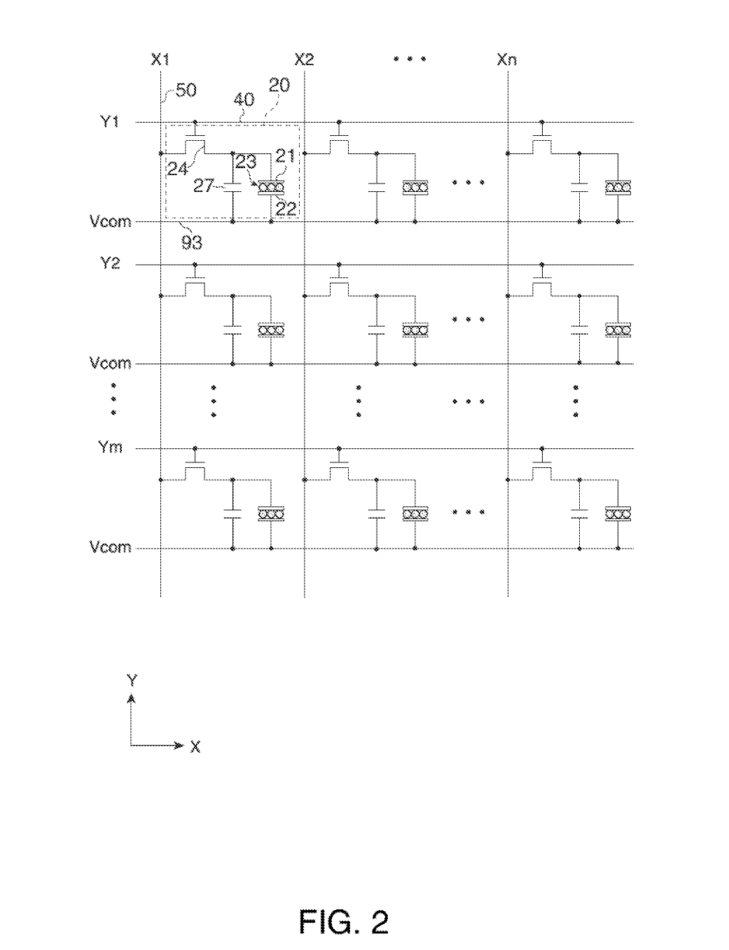

First, the overall configuration of the electrophoretic display device in accordance with the first embodiment will be described with reference to FIG. 1 and FIG. 2.

FIG. 1 is a block diagram showing the overall configuration of the electrophoretic display device in accordance with the first embodiment.

FIG. 1 shows an electrophoretic display device 1 in accordance with the embodiment that is an electrophoretic display device using an active matrix drive system, and is equipped with a display section 3, a controller 10, a scanning line drive circuit 60, a data line drive circuit 70, and a common potential supply circuit 220. It is noted that the controller 10 is an example of a “control device for an electrophoretic device” in accordance with an embodiment of the invention. Further, the scanning line drive circuit 60, the data line drive circuit 70 and the common potential supply circuit 220 compose an example of a “drive section” in accordance with an embodiment of the invention. The scanning line drive circuit 60, the data line drive circuit 70 and the common potential supply circuit 220 may generally be referred to below as a “drive section.”

The display section 3 includes pixels 20 in m lows×n columns arranged in a matrix configuration (in a two-dimensional plane). Also, the display section 3 is provided with m scanning lines 40 (i.e., scanning lines Y1, Y2, . . . , Ym) and n data lines 50 (i.e., data lines X1, X2, . . . , Xn) arranged in a manner to traverse one another. More specifically, the m scanning lines 40 extend in a row direction (i.e., an X direction), and the n data lines 50 extending in a column direction (i.e., a Y direction). The pixels 20 are disposed corresponding to intersections between the m scanning lines 40 and the n data lines 50.

The controller 10 controls operations of the scanning line drive circuit 60, the data line drive circuit 70 and the common potential supply circuit 220. The controller 10 supplies timing signals, such as, for example, a clock signal, a start pulse, and the like to each of the circuits.

The scanning line drive circuit 60 sequentially supplies a scanning signal in pulses under the control of the controller 10 to each of the scanning lines Y1, Y2, . . . , Ym during a predetermined frame period.

The data line drive circuit 70 supplies data potentials under the control of the controller 10 to the data lines X1, X2, . . . , Xn. The data potential may be one of a reference potential GND (for example, 0 volt) and a high potential VH (for example, +15 volt). As discussed below, in accordance with the present embodiment, the partial rewriting drive described above is basically employed.

The common potential supply circuit 220 supplies a common potential Vcom under the control of the controller 10 to a common potential line 93. The common potential Vcom may be either the reference potential GND (for example, 0 volt) or the high potential VH (for example, +15 volt).

Various kinds of signals are inputted in and outputted from the controller 10, the scanning line drive circuit 60, the data line drive circuit 70 and the common potential supply circuit 220. It is noted that description of those of the signals which are not particularly pertinent to the present embodiment will be omitted.

FIG. 2 is a diagram of an equivalent circuit showing the electrical configuration of the pixels 20.

As shown in FIG. 2, each of the pixels 20 is equipped with a pixel switching transistor 24, a pixel electrode 21, a counter electrode 22, an electrophoretic element 23, and a retention capacitor 27.

The pixel switching transistor 24 is composed of, for example, an N-type transistor. The pixel switching transistor 24 has a gate electrically connected to the scanning line 40, a source electrically connected to the data line 50, and a drain electrically connected to the pixel electrode 21 and the retention capacitor 27. The pixel switching transistor 24 outputs a data potential supplied from the data line drive circuit 70 (see FIG. 1) through the data line 50 to the pixel electrode 21 and the retention capacitor 27 at the timing according to a pulse-like scanning signal supplied from the scanning line drive circuit 60 (see FIG. 1) through the scanning line 40.

The data potential is supplied to the pixel electrode 21 from the data line drive circuit 70 through the data line 50 and the pixel switching transistor 24. The pixel electrode 21 is disposed opposite the counter electrode 22 with the electrophoretic element 23 placed therebetween.

The counter electrode 22 is electrically connected to the common potential line 93 through which the common potential Vcom is supplied.

The electrophoretic element 23 is composed of a plurality of microcapsules each containing electrophoretic particles.

The retention capacitor 27 is formed from a pair of electrodes disposed opposite each other through a dielectric film. One of the electrodes of the retention capacitor 27 is electrically connected to the pixel electrode 21 and the pixel switching transistor 24, and the other electrode is electrically connected to the common potential line 93. The potential of the pixel electrode 21 can be maintained for a predetermined period by the retention capacitor 27.

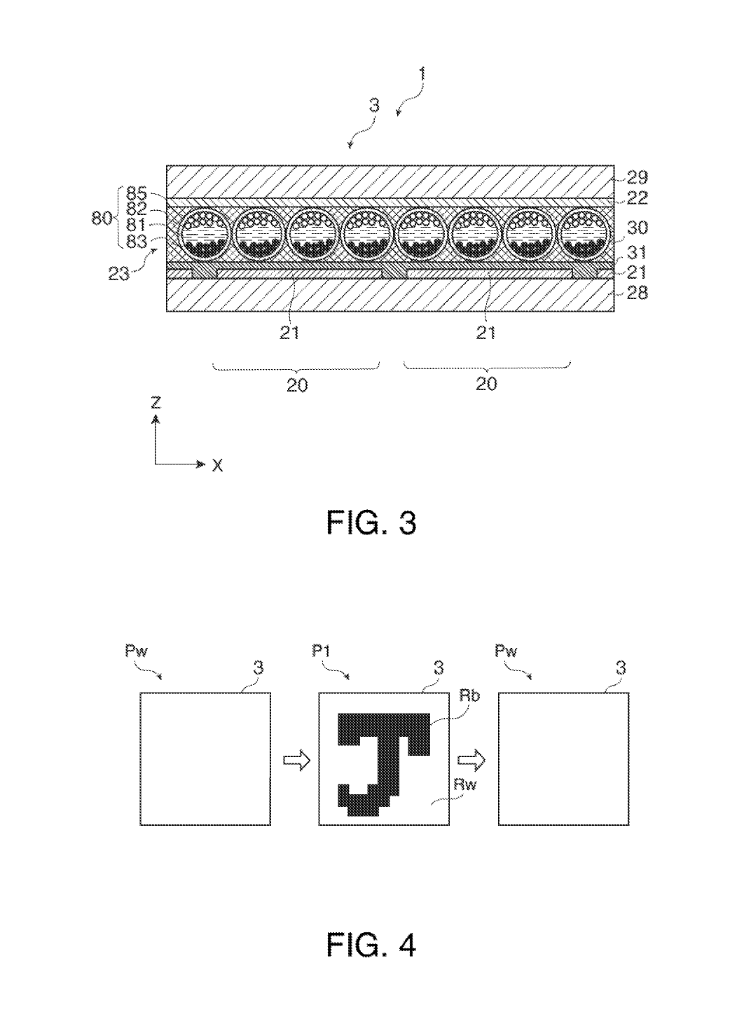

Next, a more concrete configuration of the display section 3 of the electrophoretic display device 1 will be described with reference to FIG. 3.

FIG. 3 is a cross-sectional view in part of the display section 3 of the electrophoretic display device 1.

As shown in FIG. 3, the display section 3 is configured in a manner that the electrophoretic element 23 is held between an element substrate 28 and a counter substrate 29. It is noted that the present embodiment will be described on the assumption that an image is displayed on the side of the counter substrate 29.

The element substrate 28 is a substrate made of glass, plastics, or the like. A laminate structure having the pixel switching transistors 24, the retention capacitors 27, the scanning lines 40, the data lines 50, the common potential lines 93 and the like described above with reference to FIG. 2 formed therein is formed on the element substrate 28, though its illustration is omitted. The plural pixel electrodes 21 are provided in a matrix configuration on the upper layer side of the laminate structure.

The counter substrate 29 is a transparent substrate made of, for example, glass, plastics or the like. On an opposing surface of the counter substrate 29 facing the element substrate 28, a counter electrode 22 is formed solidly, opposite the plural pixel electrodes 21. The counter electrode 22 is made of a transparent conductive material, such as, for example, magnesium silver (MgAg), indium tin oxide (ITO), indium zinc oxide (IZO), or the like.

The electrophoretic element 23 is made up of a plurality of microcapsules 80 each containing electrophoretic particles. The electrophoretic element 23 is fixed between the element substrate 28 and the counter substrate 29 by means of a binder 30 made of a resin or the like and an adhesive layer 31. It is noted that, in the manufacturing process, an electrophoretic sheet having the electrophoretic element 23 affixed in advance to the counter substrate 29 side with the binder 30 is prepared, and bonded to the element substrate 28 which is independently fabricated and has the pixel electrodes 21 and the like bonded with the adhesive layer 31, whereby the electrophoretic display device 1 in accordance with the present embodiment is formed.

One or a plurality of microcapsules 80 are disposed in each of the pixels (in other words, for each of the pixel electrodes 21) and sandwiched between the pixel electrode 21 and the counter electrode 22.

The microcapsule 80 includes a dispersion medium 81, a plurality of white particles 82 and a plurality of black particles 83 sealed in a membrane 85. The microcapsule 80 is formed in a spherical body having a grain diameter of, for example, about 50 μm.

The membrane 85 functions as an outer shell of the microcapsule 80, and may be formed from acrylic resin such as polymethyl methacrylate and polyethyl methacrylate, and polymer resin having translucency such as urea resin, gum Arabic and gelatin.

The dispersion medium 81 is a liquid in which the white particles 82 and black particles 83 are dispersed in the microcapsule 80 (in other words, within the membrane 85). As the dispersion medium 81, water; alcohol solvents (such as, methanol, ethanol, isopropanol, butanol, octanol, and methyl cellosolve); esters (such as, ethyl acetate, and butyl acetate); ketones (such as, acetone, methyl ethyl ketone, and methyl isobutyl ketone); aliphatic hydrocarbons (such as, pentane, hexane, and octane); alicyclic hydrocarbons (such as, cyclohexane and methylcyclohexane); aromatic hydrocarbons (such as, benzene, toluene, benzenes having a long-chain alkyl group (such as, xylene, hexylbenzene, butylbenzene, octylbenzene, nonylbenzene, decylbenzene, undecylbenzene, dodecylbenzene, tridecylbenzene, and tetradecylbenzene)); halogenated hydrocarbons (such as, methylene chloride, chloroform, carbon tetrachloride, and 1,2-dichloroethane); carboxylates, and any one of other various oils may be used alone or in combination, and may be further mixed with a surfactant.

The white particles 82 are particles (polymer or colloid) made of white pigment, such as, for example, titanium dioxide, flowers of zinc (zinc oxide), antimony oxide, or the like, and may be negatively charged.

The black particles 83 are particles (polymer or colloid) made of black pigment, such as, for example, aniline black, carbon black or the like, and may be positively charged.

Accordingly, the white particles 82 and the black particles 83 can move in the dispersion medium 81 by an electric field generated by a potential difference between the pixel electrode 21 and the counter electrode 22.

A charge-controlling agent made of particles, such as, electrolytes, surfactant, metal soap, resin, rubber, oil, varnish or compound, a dispersing agent, such as, a titanium coupling agent, an aluminum coupling agent, a silane coupling agent, or the like, lubricant, stabilizing agent, and the like may be added to the aforementioned pigment as necessary.

In FIG. 3, when voltage is applied between the pixel electrode 21 and the counter electrode 22 to set the potential on the counter electrode 22 to be relatively higher than the other, the positively charged black particles 83 are drawn to the side of the pixel electrode 21 within the microcapsules 80 by a Coulomb force, and the negatively charged white particles 82 are drawn to the side of the counter electrode 22 within the microcapsules 80 by a Coulomb force. As a result, the white particles 82 gather on the side of the display surface (in other words, on the side of the counter electrode 22) within the microcapsules 80, whereby the color of the white particles (i.e., white) is displayed at the display surface of the display section 3. On the other hand, when voltage is applied between the pixel electrode 21 and the counter electrode 22 to set the potential on the pixel electrode 21 to be relatively higher than the other, the negatively charged white particles 82 are drawn to the side of the pixel electrode 21 within the microcapsules 80 by a Coulomb force, and the positively charged black particles 83 are drawn to the side of the counter electrode 22 within the microcapsules 80 by a Coulomb force. As a result, the black particles 83 gather on the side of the display surface within the microcapsules 80, whereby the color of the black particles (i.e., black) is displayed at the display surface of the display section 3.

It is noted that the pigment used for the white particles 82 or the black particles 83 may be replaced with other pigment of different color, such as, red, green, blue or the like, whereby red color, green color, blue color or the like can be displayed.

Next, a control method for controlling an electrophoretic display device in accordance with an embodiment will be described with reference to FIGS. 4 through 7. The control method for controlling the above-described electrophoretic display device 1 will be described, using an example in which an image displayed at the display section 3 is rewritten from an image Pw that is an all-white image to an image P1 that is a two-gray level image in black and white, and the image P1 is rewritten again to the image Pw that is an all-white image.

FIG. 4 is a plan view showing an example of images sequentially displayed at the display section 3.

As shown in FIG. 4, the image Pw is an all-white image that is composed of white alone. The image P1 is a two-gray level image in black and white that is composed of two gray levels of black and white, and includes a white image section Rw having a white color, and a black image section Rb having a black color. It is noted that the image P1 is an example of the “first image” in accordance with an embodiment of the invention, and the image Pw is an example of the “second image” in accordance with an embodiment of the invention.

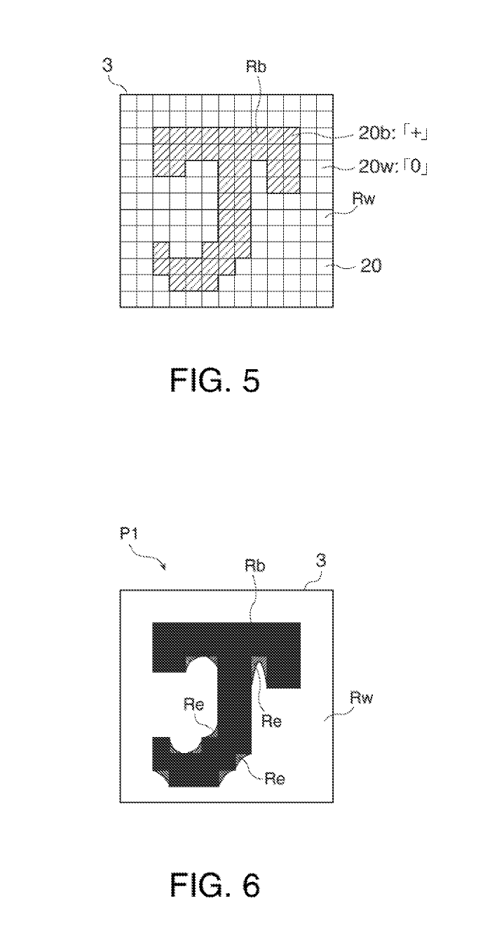

FIG. 5 is a conceptual figure that conceptually shows voltages applied between the pixel electrodes 21 and the counter electrode 22 of the respective plural pixels 20 when the image Pw is rewritten to the image P1. It is noted that, in FIG. 5, “+” is shown to indicate that voltage for setting the potential on the pixel electrode 21 higher than the potential on the counter electrode 22 is applied between the pixel electrode 21 and the counter electrode 22, and “0” is shown to indicate that no voltage is applied between the pixel electrode 21 and the counter electrode 22.

As shown in FIG. 5, in the present embodiment, the partial rewriting drive described above is basically used. More specifically, in accordance with the present embodiment, when an image shown at the display section 3 is rewritten from the image Pw to the image P1, voltage for setting the potential on the pixel electrode 21 side higher than the potential on the counter electrode 22 side is supplied between the pixel electrode 21 and the counter electrode 22 (in other words, a high potential VH is supplied as the data potential to the pixel electrode 21 and a reference potential GND is supplied as the common potential Vcom to the counter electrode 22) for pixels 20b whose gray level is to be changed from white to black (in other words, pixels 20 corresponding to the black image section Rb), and no voltage is applied between the pixel electrode 21 and the counter electrode 22 (in other words, the reference potential GND is supplied as the data potential to the pixel electrode 21 and the reference potential GND is supplied as the common potential Vcom to the counter electrode 22) for pixels 20w whose gray level is not changed (in other words, whose gray level is to be maintained in white) (in other words, pixels 20 corresponding to the white image section Rw). By this operation, at the pixels 20b corresponding to the black image section Rb whose gray level is to be changed from white to black, the black particles 83 gather on the side of the display surface (in other words, on the side of the counter electrode 22) thereby displaying a black color. At the pixels 20w corresponding to the white image section Rw whose gray level is not changed, basically, the white particles 82 and the black particles 83 scarcely move or do not move at all, and the gray level is maintained in white.

FIG. 6 is a plan view showing an example of blurry sections Re that can occur when voltages are applied to the plural pixels 20 for rewriting the image displayed at the display section 3 from the image Pw to the image P1 in a manner described with reference to FIG. 5.

As shown in FIG. 6, in the present embodiment, the image Pw is rewritten to the image P1 by the partial rewriting drive described above with reference to FIG. 5. This leaves open the possibility that boundary portions between the black image section Rb displayed in black and the white image section Rw displayed in white among the image displayed at the display section may be displayed blurry. In other words, the contour portions of the black image section Rb may be displayed as if they spread (or bulge) into the white image section Rw side. According to the research conducted by the inventor, it has been identified that, when the image Pw is rewritten to the image P1, the portions that appear to be blurry (hereafter suitably referred to as the “blurry sections Re”) occur in relatively numerous places at those of the pixels 20, among the pixels 20w whose gray level is supposed to be maintained in white (in other words, pixels 20 at which no voltage is applied), which have two or more sides adjacent (or adjoining) to the pixels 20b whose gray level is supposed to change from white to black (in other words, those of the pixels 20 to which voltage that sets the potential on the pixel electrode 21 side higher than the potential on the counter electrode 22 side is applied). In other words, as shown in FIG. 6, the blurry sections Re tend to occur locally, adjacent to, for example, portions where the black image section Rb bents. There is a possibility that such blurry sections Re may remain as contour afterimages, if the image displayed at the display section 3 is rewritten again from the image P1 to an image Pw that is an all-white image by applying voltage only to those of the pixels 20 corresponding to the black image portion Rb.

In light of the above, in accordance with the present embodiment, when the image displayed at the display section 3 is rewritten from the image P1 to the image Pw that is an all-white image, voltage is applied between the pixel electrode 21 and the counter electrode 22 of each of the plural pixels 20 as follows.

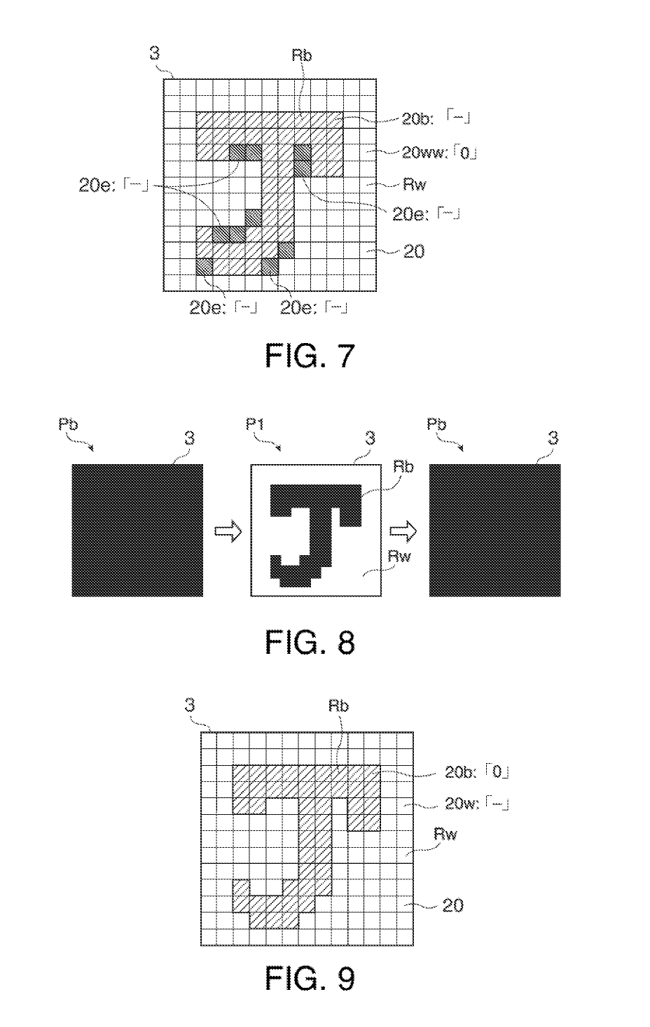

FIG. 7 is a conceptual figure that conceptually shows voltages applied between the pixel electrodes 21 and the counter electrode 22 of the multiple pixels 20 when the image P1 is rewritten to the image Pw. It is noted that, in FIG. 7, “−” is shown to indicate that voltage for setting the potential on the pixel electrode 21 side lower than the potential on the counter electrode 22 side is applied between the pixel electrode 21 and the counter electrode 22, and “0” is shown to indicate that no voltage is applied between the pixel electrode 21 and the counter electrode 22. Also, the voltage that sets the potential on the pixel electrode 21 side lower than the potential on the counter electrode 22 side (in other words, voltage of “−”) is an example of the “voltage corresponding to the first gray level” in accordance with the present embodiment.

As shown in FIG. 7, in accordance with the present embodiment in particular, when the image displayed at the display section 3 is rewritten from the image P1 including the white image section Rw and the black image section Rb to the image Pw that is an all-white image, the controller 10 controls the drive section such that, for those of the pixels 20 whose gray level to be displayed changes from black to white among the plural pixels 20 (in other words, the pixels 20b corresponding to the black image section Rb), voltage that sets the potential on the pixel electrode 21 side lower than the potential on the counter electrode 22 side is applied between the pixel electrode 21 and the counter electrode 22 (in other words, the reference potential GND is supplied as the data potential to the pixel electrode 21, and the high potential VH is supplied as the common potential Vcom to the counter electrode 22); for pixels 20e, among those of the pixels 20 whose gray level to be displayed does not change and remains to be white, having two or more sides adjacent to those of the pixels 20 which display black when the image P1 is displayed at the display section 3 (in other words, pixels 20b corresponding to the black image section Rb) among the plural pixels 20, voltage that sets the potential on the pixel electrode 21 side lower than the potential on the counter electrode 22 side is applied between the pixel electrode 21 and the counter electrode 22 (in other words, the reference potential GND is supplied as the data potential to the pixel electrode 21 and the high potential VH is supplied as the common potential Vcom to the counter electrode 22); and for pixels 20ww that are those of the pixels 20 other than the pixels 20e among those of the pixels 20 whose gray level to be displayed does not change and remains to be white among the plural pixels 20, no voltage is applied between the pixel electrode 21 and the counter electrode 22. In other words, in accordance with the present embodiment, when the image P1 displayed at the display section 3 is rewritten to the image Pw that is an all-white image, the drive section is controlled by the controller 10 such that voltage is applied not only to the pixels 20b corresponding to the black image section Rb, but also to the pixels 20e having two or more sides adjacent to the pixels 20b, and no voltage is applied to the pixels 20ww other than the pixels 20b and 20e. It is noted that the pixel 20b is an example of the “first pixel” of the present embodiment, the pixel 20e is an example of the “second pixel” of the present embodiment, and the pixel 20ww is an example of the “third pixel” of the present embodiment.

Accordingly, white color can be securely displayed at each of the pixels 20b corresponding to the black image section Rb and the pixels 20e having two or more sides adjacent to the pixels 20b (in other words, the pixels 20e corresponding to the blurry sections Re). Stated otherwise, the black image section Rb and the blurry sections Re can be securely erased, and the occurrence in which the blurry sections Re remain as contour afterimages can be reduced. As a result, the image Pw that is an all-white image can be securely displayed at the display section 3.

Moreover, in accordance with the present embodiment in particular, the drive section is controlled by the controller 10 such that voltage is applied between the pixel electrode 21 and the counter electrode 22 of each of the pixels 20e having two or more sides adjacent to the pixels 20b among the pixels 20 having at least a side adjacent to the pixels 20b corresponding to the black image section Rb, but no voltage is applied between the pixel electrode 21 and the counter electrode 22 of each of the pixels 20 having only one side adjacent to the pixels 20b. Therefore, destruction of the DC balance can be suppressed better, compared to, for example, a case where, for the purpose of erasing contour afterimages, voltage is applied between the pixel electrodes 21 and the counter electrode 22 of all of the pixels 20 having sides adjacent to the pixels 20b corresponding to the black image section Rb. Accordingly, the reliability of the electrophoretic display device 1 can be improved.

As described above, in accordance with the present embodiment, while destruction of the DC balance can be suppressed, generation of contour afterimages can be reduced. As a result, high quality images can be displayed at the display section 3, and the reliability of the electrophoretic display device 1 can be improved.

### Modification Example

The first embodiment has been described above, using an example in which, as shown in FIG. 4, an image displayed at the display section 3 is rewritten from an image Pw that is an all-white image to an image P1 that is a two-gray level image in black and white, and the image P1 is rewritten again to an image Pw that is an all-white image. The invention is also applicable to a case where, as shown in FIG. 8, an image displayed at the display section 3 is rewritten from an image Pb that is an all-black image to an image P1 that is a two-gray level image in black and white, and the image P1 is rewritten again to an image Pb that is an all-black image.

FIG. 8 is a plan view showing another example of images sequentially displayed at the display section 3.

As shown in FIG. 8, the image Pb is an all-black image that is composed of black alone. The image P1 is a two-gray level image in black and white that is composed of two gray levels of black and white, and includes a white image section Rw having a white color, and a black image section Rb having a black color. It is noted that the image P1 is an example of the “first image” in accordance with the embodiment of the invention, and the image Pb is an example of the “second image” in accordance with the embodiment of the invention.

FIG. 9 is a conceptual figure that conceptually shows voltages applied between the pixel electrodes 21 and the counter electrode 22 of the respective plural pixels 20 when the image Pb is rewritten to the image P1. It is noted that, in FIG. 9, “−” is shown to indicate that voltage for setting the potential on the pixel electrode 21 side lower than the potential on the counter electrode 22 side is applied between the pixel electrode 21 and the counter electrode 22, and “0” is shown to indicate that no voltage is applied between the pixel electrode 21 and the counter electrode 22.

As shown in FIG. 9, in the present modification embodiment, basically, the partial rewriting drive described above is used, in a similar manner as the first embodiment described above. More specifically, in accordance with the present modification example, when an image displayed at the display section 3 is rewritten from the image Pb to the image P1, voltage for setting the potential on the pixel electrode 21 side lower than the potential on the counter electrode 22 side is supplied between the pixel electrode 21 and the counter electrode 22 (in other words, the reference potential GND is supplied as the data potential to the pixel electrode 21 and a high potential VH is supplied as the common potential Vcom to the counter electrode 22) for pixels 20w whose gray level is to be changed from black to white (in other words, pixels 20 corresponding to the white image section Rw), and no voltage is applied between the pixel electrode 21 and the counter electrode 22 (in other words, the reference potential GND is supplied as the data potential to the pixel electrode 21 and the reference potential GND is supplied as the common potential Vcom to the counter electrode 22) for pixels 20b whose gray level is not changed (in other words, whose gray level is to be maintained in black) (in other words, pixels 20 corresponding to the black image section Rb). By this operation, at the pixels 20w corresponding to the white image section Rw whose gray level is to be changed from black to white, the white particles 82 gather on the side of the display surface (in other words, on the side of the counter electrode 22) thereby displaying a white color. At the pixels 20b corresponding to the black image section Rb whose gray level is not changed, basically, the white particles 82 and the black particles 83 scarcely move or do not move at all, and the gray level is maintained in black.

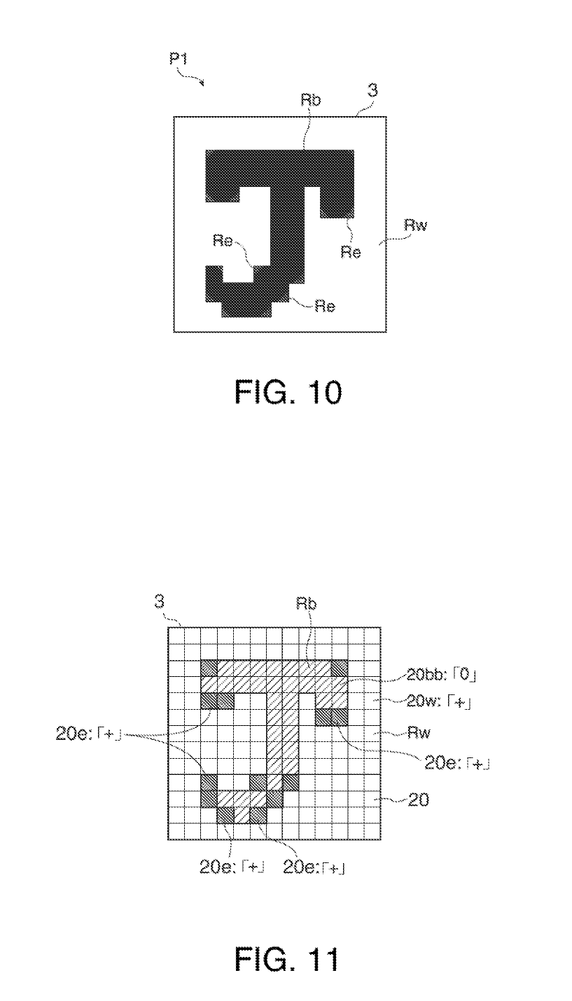

FIG. 10 is a plan view showing an example of blurry sections Re that can occur when voltages are applied to the plural pixels 20 for rewriting the image displayed at the display section 3 from the image Pb to the image P1 in a manner described with reference to FIG. 9.

As shown in FIG. 10, in the present example, the image Pb is rewritten to the image P1 by the partial rewriting drive described above with reference to FIG. 9. This leaves open the possibility that boundary portions between the white image section Rw displayed in white and the black image section Rb displayed in black among the image displayed at the display section 3 may be displayed blurry. In other words, the contour portions of the white image section Rw may be displayed as if they spread into the black image section Rb side (in other words, the contour of the black image section Rb appears as if it is partially narrowed). According to the research conducted by the inventor, it has been identified that, when the image Pb is rewritten to the image P1, the blurry portions Re that appear to be blurry occur in relatively numerous places at those of the pixels 20, among the pixels 20b whose gray level is supposed to be maintained in black (in other words, pixels 20 at which no voltage is applied), which have two or more sides adjacent to the pixels 20w whose gray level is supposed to change from black to white (in other words, those of the pixels 20 to which voltage that sets the potential on the pixel electrode 21 side lower than the potential on the counter electrode 22 side is applied). In other words, as shown in FIG. 10, the blurry sections Re tend to occur locally, adjacent to, for example, portions where the white image section Rw bents. There is a possibility that such blurry sections Re may remain as contour afterimages, if the image displayed at the display section 3 is rewritten again from the image P1 to an image Pb that is an all-black image by applying voltage only to those of the pixels 20 corresponding to the white image portion Rw.

In light of the above, in accordance with the present modification example, when the image displayed at the display section 3 is rewritten from the image P1 to the image Pb that is an all-black image, voltage is applied between the pixel electrode 21 and the counter electrode 22 of each of the plural pixels 20 as follows.

FIG. 11 is a conceptual figure that conceptually shows voltages to be applied between the pixel electrodes 21 and the counter electrode 22 of the multiple pixels 20 when the image P1 is rewritten to the image Pb. It is noted that, in FIG. 11, “+” is shown to indicate that voltage for setting the potential on the pixel electrode 21 side higher than the potential on the counter electrode 22 side is applied between the pixel electrode 21 and the counter electrode 22, and “0” is shown to indicate that no voltage is applied between the pixel electrode 21 and the counter electrode 22. Also, in the present modification example, the voltage that sets the potential on the pixel electrode 21 side higher than the potential on the counter electrode 22 side (in other words, voltage of “+”) is an example of the “voltage corresponding to the first gray level” in accordance with the present embodiment.

As shown in FIG. 11, in accordance with the present embodiment in particular, when the image displayed at the display section 3 is rewritten from the image P1 including the white image section Rw and the black image section Rb to the image Pb that is an all-black image, the controller 10 controls the drive section such that, for those of the pixels 20 whose gray level to be displayed changes from white to black among the plural pixels 20 (in other words, the pixels 20w corresponding to the white image section Rw), voltage that sets the potential on the pixel electrode 21 side higher than the potential on the counter electrode 22 side is applied between the pixel electrode 21 and the counter electrode 22 (in other words, the high potential VH is supplied as the data potential to the pixel electrode 21, and the reference potential GND is supplied as the common potential Vcom to the counter electrode 22); for pixels 20e, among those of the pixels 20 whose gray level to be displayed does not change and remains to be black, which have two or more sides adjacent to those of the pixels 20 which display white when the image P1 is displayed at the display section 3 (in other words, pixels 20w corresponding to the white image section Rw) among the plural pixels 20, voltage that sets the potential on the pixel electrode 21 side higher than the potential on the counter electrode 22 side is applied between the pixel electrode 21 and the counter electrode 22 (in other words, the high potential VH is supplied as the data potential to the pixel electrode 21 and the reference potential GND is supplied as the common potential Vcom to the counter electrode 22); and for pixels 20bb that are those of the pixels 20 other than the pixels 20e among those of the pixels 20 whose gray level to be displayed does not change and remains to be black among the plural pixels 20, no voltage is applied between the pixel electrode 21 and the counter electrode 22. In other words, in accordance with the present embodiment, when the image P1 displayed at the display section 3 is rewritten to the image Pb that is an all-black image, the drive section is controlled by the controller 10 such that voltage is applied not only to the pixels 20w corresponding to the white image section Rw, but also to the pixels 20e having two or more sides adjacent to the pixels 20w, and no voltage is applied to the pixels 20bb other than the pixels 20w and 20e. It is noted that the pixel 20w is an example of the “first pixel” of the present embodiment, the pixel 20e is an example of the “second pixel” of the present embodiment, and the pixel 20bb is an example of the “third pixel” of the present embodiment.

Accordingly, black color can be securely displayed at each of the pixels 20w corresponding to the white image section Rw and the pixels 20e having two or more sides adjacent to the pixels 20w (in other words, the pixels 20e corresponding to the blurry sections Re). Stated otherwise, the white image section Rw and the blurry sections Re can be securely erased, and the occurrence of contour afterimages derived from the blurry sections Re can be reduced. As a result, the image Pb that is an all-black image can be securely displayed at the display section 3.

In accordance with the present embodiment in particular, the drive section is controlled by the controller 10 such that voltage is applied between the pixel electrode 21 and the counter electrode 22 of each of the pixels 20e having two or more sides adjacent to the pixels 20w among the pixels 20 having at least a side adjacent to the pixels 20w corresponding to the white image section Rw, but no voltage is applied between the pixel electrode 21 and the counter electrode 22 of each of the pixels 20 having only one side adjacent to the pixels 20w. Therefore, destruction of the DC balance can be suppressed better, compared to, for example, a case where, for the purpose of erasing contour afterimages, voltage is applied between the pixel electrodes 21 and the counter electrode 22 of all of the pixels 20 having sides adjacent to the pixels 20w corresponding to the white image section Rw. Accordingly, the reliability of the electrophoretic display device 1 can be improved.

As described above, in accordance with the present embodiment, while destruction of the DC balance can be suppressed, generation of contour afterimages can be reduced. As a result, high quality images can be displayed at the display section 3, and the reliability of the electrophoretic display device 1 can be improved.

### Second Embodiment

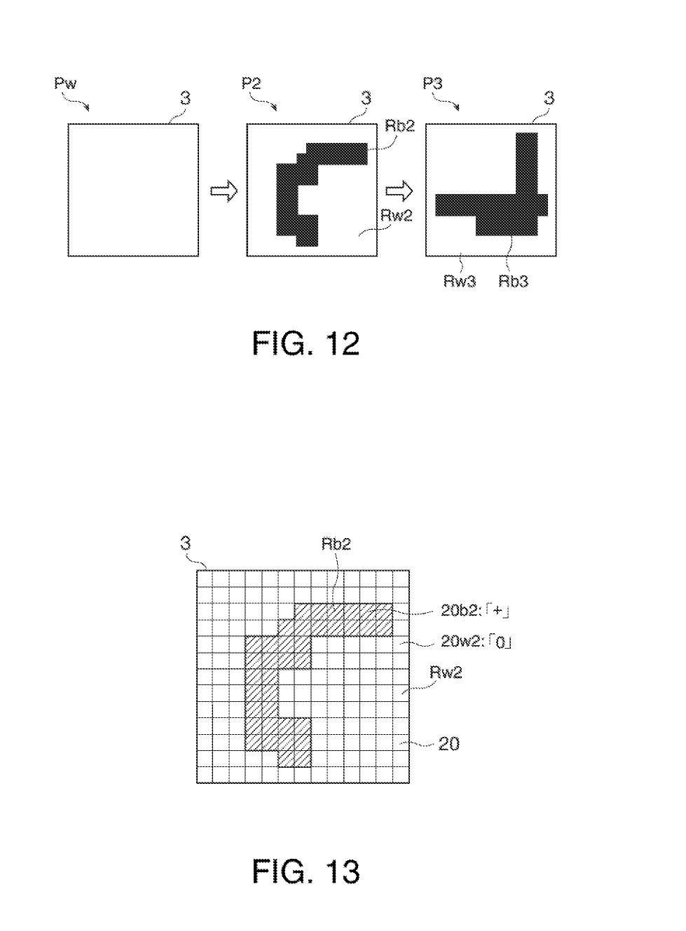

An electrophoretic display device in accordance with a second embodiment of the invention will be described with reference to FIGS. 12 through 15.

An electrophoretic display device in accordance with the second embodiment is different from the electrophoretic display device 1 in accordance with the first embodiment described above in that the data line drive circuit 70 is configured to be capable of supplying a reference voltage GND (for example, 0 volt), a high potential VH (for example, +15 volt) or a low potential VL (for example, −15 volt), as data potentials, and the common potential supply circuit 220 supplies a reference potential GND (for example, 0 volt) as a common potential Vcom, and is configured generally in a similar manner as the electrophoretic display device 1 in accordance with the first embodiment described above in other respect.

Next, a control method for controlling an electrophoretic display device in accordance with an embodiment will be described, using an example in which, as shown in FIG. 12, an image displayed at the display section 3 is rewritten from an image Pw that is an all-white image to an image P2 that is a two-gray level image in black and white, and the image P2 is rewritten again to an image P3 that is a two-gray level image in black and white different from the image P2.

FIG. 12 is a plan view showing another example of images sequentially displayed at the display section 3.

As shown in FIG. 12, the image Pw is an all-white image that is composed of white alone. The image P2 is a two-gray level image in black and white that is composed of two gray levels of black and white, and includes a white image section Rw2 composed of a white color, and a black image section Rb2 composed of a black color. The image P3 is a two-gray level image in black and white different from the image P2, and includes a white image section Rw3 composed of a white color, and a black image section Rb3 composed of a black color. It is noted that the image P2 is an example of the “first image” in accordance with the embodiment of the invention, and the image Pw is an example of the “second image” in accordance with the embodiment of the invention.

FIG. 13 is a conceptual figure that conceptually shows voltages applied between the pixel electrodes 21 and the counter electrode 22 of the respective plural pixels 20 when the image Pw is rewritten to the image P2. It is noted that, in FIG. 13, “+” is shown to indicate that voltage for setting the potential on the pixel electrode 21 side higher than the potential on the counter electrode 22 side is applied between the pixel electrode 21 and the counter electrode 22, and “0” is shown to indicate that no voltage is applied between the pixel electrode 21 and the counter electrode 22.

As shown in FIG. 13, in accordance with the present embodiment, basically, the partial rewriting drive described above is used. More specifically, in accordance with the present embodiment, when the image displayed at the display section 3 is rewritten from the image Pw to the image P2, for those of the pixels 20 whose gray level is to be changed from white to black (in other words, the pixels 20b2 corresponding to the black image section Rb2), voltage that sets the potential on the pixel electrode 21 side higher than the potential on the counter electrode 22 side is applied between the pixel electrode 21 and the counter electrode 22 (in other words, the high potential VH is supplied as the data potential to the pixel electrode 21, and the reference potential GND is supplied as the common potential Vcom to the counter electrode 22); and for those of the pixels 20 whose gray level is not changed (in other words, whose gray level is to be maintained in white) (more specifically, the pixels 20w2 corresponding to the white image section Rw2), no voltage is applied between the pixel electrode 21 and the counter electrode 22 (in other words, the reference potential GND is supplied as the data potential to the pixel electrode 21 and the reference potential GND is supplied as the common potential Vcom to the counter electrode 22). By this operation, at the pixels 20b2 corresponding to the black image section Rb2 whose gray level is to be changed from white to black, the black particles 83 gather on the side of the display surface (in other words, on the side of the counter electrode 22) thereby displaying a black color. At the pixels 20w2 corresponding to the white image section Rw2 whose gray level is not changed, basically, the white particles 82 and the black particles 83 scarcely move or do not move at all, and the gray level is maintained in white.

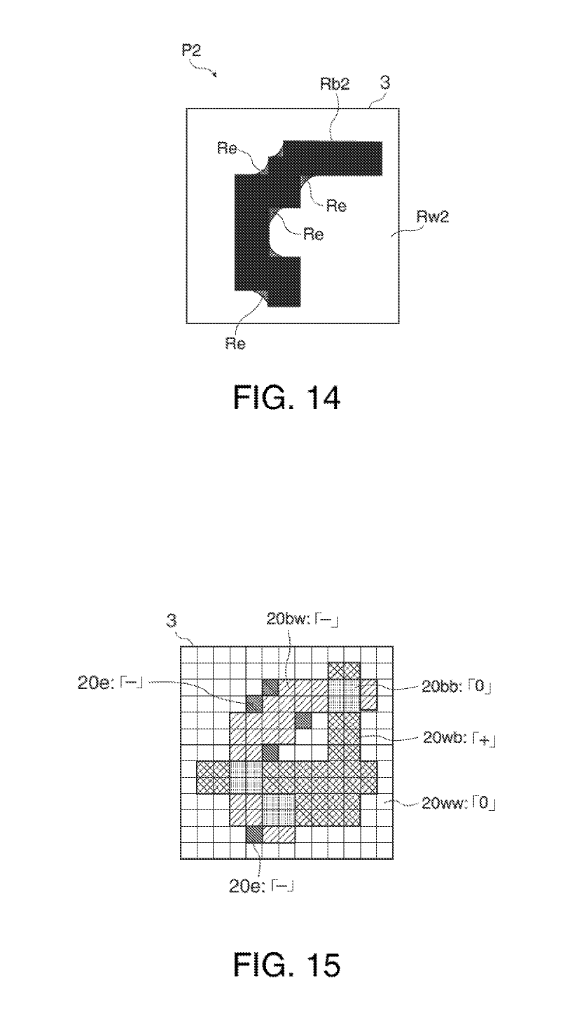

FIG. 14 is a plan view showing an example of blurry sections Re that can occur when voltages are applied to the plural pixels 20 for rewriting the image displayed at the display section 3 from the image Pw to the image P2 in a manner described with reference to FIG. 13.

As shown in FIG. 14, in the present embodiment, the image Pw is rewritten to the image P2 by the partial rewriting drive described above with reference to FIG. 13. This leaves open the possibility that boundary portions between the black image section Rb2 displayed in black and the white image section Rw2 displayed in white among the image displayed at the display section 3 may be displayed blurry. In other words, the contour portions of the black image section Rb2 may be displayed as if they spread (or bulge) into the white image section Rw2 side. According to the research conducted by the inventor, it has been identified that, when the image Pw is rewritten to the image P2, the blurry sections Re that appear to be blurry occur in relatively numerous places at those of the pixels 20, among the pixels 20w2 whose gray level is supposed to be maintained in white (in other words, those of the pixels 20 at which no voltage is applied), which have two or more sides adjacent to the pixels 20b2 whose gray level is supposed to change from white to black (in other words, those of the pixels 20 to which voltage that sets the potential on the pixel electrode 21 side higher than the potential on the counter electrode 22 side is applied). In other words, as shown in FIG. 14, the blurry sections Re tend to occur locally, adjacent to, for example, portions where the black image section Rb2 bents. There is a possibility that such blurry sections Re may remain entirely or partially as contour afterimages, if the image displayed at the display section 3 is rewritten from the image P2 to the image P3 by applying voltage only to those of the pixels 20 whose gray level is to be changed.

In light of the above, in accordance with the present embodiment, when the image displayed at the display section 3 is rewritten from the image P2 to the image P3, voltage is applied between the pixel electrode 21 and the counter electrode 22 of each of the plural pixels 20 as follows.

FIG. 15 is a conceptual figure that conceptually shows voltages to be applied between the pixel electrodes 21 and the counter electrode 22 of the multiple pixels 20 when the image P2 is rewritten to the image P3. It is noted that, in FIG. 15, “−” is shown to indicate that voltage for setting the potential on the pixel electrode 21 side lower than the potential on the counter electrode 22 side is applied between the pixel electrode 21 and the counter electrode 22, and “0” is shown to indicate that no voltage is applied between the pixel electrode 21 and the counter electrode 22. Also, the voltage that sets the potential on the pixel electrode 21 side lower than the potential on the counter electrode 22 side (in other words, voltage of “−”) is an example of the “voltage corresponding to the first gray level” in accordance with the present embodiment.

As shown in FIG. 15, in accordance with the present embodiment in particular, when the image displayed at the display section 3 is rewritten from the image P2 including the white image section Rw2 and the black image section Rb2 to the image P3 including the white image section Rw3 and the black image section Rb3, the drive section is controlled by the controller 10 such that, for those of the pixels 20 whose gray level to be displayed changes from black to white among the plural pixels 20 (in other words, pixels 20bw corresponding to the black image section Rb2 and also corresponding to the white image section Rw3), voltage that sets the potential on the pixel electrode 21 side lower than the potential on the counter electrode 22 side is applied between the pixel electrode 21 and the counter electrode 22 (in other words, the low potential VL is supplied as the data potential to the pixel electrode 21, and the reference potential GND is supplied as the common potential Vcom to the counter electrode 22); for pixels 20e, among those of the pixels 20 whose gray level to be displayed does not change and remains to be white, having two or more sides adjacent to those of the pixels 20 which display black when the image P2 is displayed at the display section 3 (in other words, pixels 20b2 corresponding to the black image section Rb2) among the plural pixels 20, voltage that sets the potential on the pixel electrode 21 side lower than the potential on the counter electrode 22 side is applied between the pixel electrode 21 and the counter electrode 22 (in other words, the low potential VL is supplied as the data potential to the pixel electrode 21 and the reference potential GND is supplied as the common potential Vcom to the counter electrode 22); for pixels 20ww other than the pixels 20e among those of the pixels 20 whose gray level to be displayed does not change and remains to be white among the plural pixels 20, no voltage is applied between the pixel electrode 21 and the counter electrode 22 (in other words, the reference potential GND is supplied as the data potential to the pixel electrode 21 and the reference potential GND is supplied as the common potential Vcom to the counter electrode 22); for those of the pixels 20 whose gray level to be displayed changes from white to black among the plural pixels 20 (in other words, pixels 20wb corresponding to the white image section Rw2 and also corresponding to the black image section Rb3), voltage that sets the potential on the pixel electrode 21 side higher than the potential on the counter electrode 22 side is applied between the pixel electrode 21 and the counter electrode 22 (in other words, the high potential HV is supplied as the data potential to the pixel electrode 21, and the reference potential GND is supplied as the common potential Vcom to the counter electrode 22); and for those of the pixels 20 whose gray level to be displayed does not change and remains to be black among the plural pixels 20 (in other words, pixels 20bb corresponding to the black image section Rb2 and also corresponding to the black image section Rb3), no voltage is applied between the pixel electrode 21 and the counter electrode 22.

In other words, in accordance with the present embodiment, when the image P2 displayed at the display section 3 is rewritten to the image P3, the drive section is controlled by the controller 10 such that voltage that sets the potential on the pixel electrode 21 side lower than the potential on the counter electrode 22 side is applied not only to the pixels 20bw whose gray level to be displayed is changed from black to white, and also to the pixels 20e having two or more sides adjacent to the pixels 20bw among those of the pixels 20 whose gray level to be displayed does not change and remains to be white; voltage that sets the potential on the pixel electrode 21 side higher than the potential on the counter electrode 22 side is applied to the pixels 20wb whose gray level to be displayed is changed from white to black; and no voltage is applied to the pixels 20bb and 20ww among the pixels 20 other than the pixels 20bw, 20e and 20wb. It is noted that the pixel 20bw is an example of the “first pixel” of the present embodiment, the pixel 20e is an example of the “second pixel” of the present embodiment, the pixel 20ww is an example of the “third pixel” of the present embodiment, the pixel 20wb is an example of the “fourth pixel” of the present embodiment, and the pixel 20bb is an example of the “fifth pixel” of the present embodiment.

Accordingly, white color can be securely displayed at each of the pixels 20bw whose gray level to be displayed changes from black to white, and the pixels 20e having two or more sides adjacent to the pixels 20bw (in other words, the pixels 20e corresponding to the blurry sections Re). In other words, the black image section Rb2 and the blurry sections Re can be securely erased, and the occurrence of contour afterimages derived from the blurry sections Re can be reduced. Moreover, black color can be securely displayed at each of the pixels 20wb whose gray level to be displayed changes from white to black and the pixels 20bb whose gray level to be displayed does not change and remains to be black. As a result, the image P3 that is a two-gray level image in black and white can be securely displayed at the display section 3.

Furthermore, in accordance with the present embodiment in particular, the drive section is controlled by the controller 10 such that voltage is applied between the pixel electrode 21 and the counter electrode 22 of each of the pixels 20e having two or more sides adjacent to the pixels 20b2 among the pixels 20 having at least a side adjacent to the pixels 20b2 corresponding to the black image section Rbw2, but no voltage is applied between the pixel electrode 21 and the counter electrode 22 of each of the pixels 20 having only one side adjacent to the pixels 20b. Therefore, destruction of the DC balance can be suppressed better, compared to, for example, a case where, for the purpose of erasing contour afterimages, voltage is applied between the pixel electrodes 21 and the counter electrode 22 of all of the pixels 20 having sides adjacent to the pixels 20b2 corresponding to the black image section Rb2, among those of the pixels 20 whose gray level to be displayed does not change and remains in white. Accordingly, the reliability of the electrophoretic display device can be improved.

Moreover, in accordance with the present embodiment, an image displayed at the display section 3 can be directly rewritten from the image P2 to the image P3, without displaying an all-white image or an all-black image at the display section 3.

Electronic Apparatus

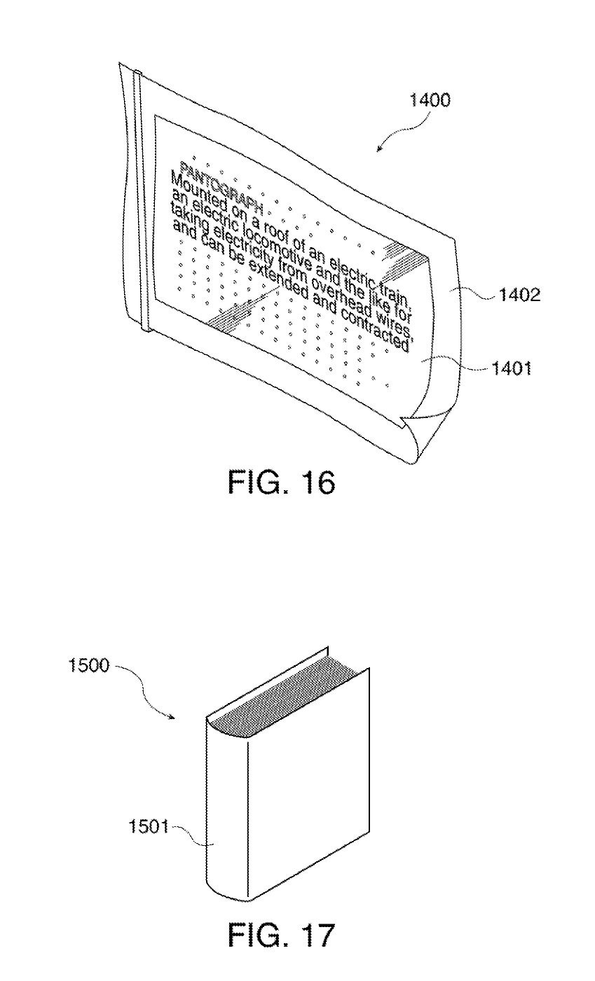

Next, electronic apparatuses using the above-described electrophoretic display device will be described with reference to FIGS. 16 and 17. Examples in which the above-described electrophoretic display device is applied to an electronic paper and an electronic notebook will be described.

FIG. 16 is a perspective view showing the configuration of an electronic paper 1400.

As shown in FIG. 16, the electronic paper 1400 is equipped with the electrophoretic display device in accordance with the embodiment described above as a display section 1401. The electronic paper 1400 is flexible and includes a sheet body 1402 composed of a rewritable sheet with texture and flexibility similar to those of existing paper.

FIG. 17 is a perspective view showing the composition of an electronic notebook 1500.

As shown in FIG. 17, the electronic notebook 1500 is configured such that multiple sheets of electronic paper 1400 shown in FIG. 16 are bundled and placed between covers 1501. The covers 1501 may be equipped with, for example, a display data input device (not shown) for inputting display data transmitted from, for example, an external apparatus. Accordingly, display contents can be changed or updated in accordance with the display data while the multiple sheets of electronic paper are bundled together.

The electronic paper 1400 and the electronic notebook 1500 described above are equipped with the electrophoretic display devices in accordance with the embodiment of the invention described above, such that high quality image display can be performed.

In addition to the above, the electrophoretic display device in accordance with the embodiment described above is also applicable to display sections of other electronic apparatuses, such as, wrist watches, portable telephones, portable audio apparatuses and the like.

Furthermore, the invention is also applicable to display devices that use electronic powder particles, in addition to electrophoretic display devices. It is noted that, in the embodiments described above, an example is described in which the white particles 82 are negatively charged, and the black particles 83 are positively charged. However, the white particles 82 may be positively charged, and the black particles 83 may be negatively charged. Also, the electrophoretic element 23 is not limited to the configuration that has the microcapsules 80, and may have a configuration in which electrophoretic dispersion medium and electrophoretic particles are stored in spaces divided by partition walls.

Also, in the embodiments described above, the reference potential GND, the high potential VH or the low potential VL is applied as the common potential Vcom to the counter electrode 22. However, in consideration of fluctuation of the potential of the pixel electrode 21 caused by, for example, field-through, the common potential Vcom may have a value slightly different from each of these potentials. Even in this case, in the present specification, the common potential Vcom is assumed to be the same potential as the reference potential GND, the high potential VH or the low potential VL. It is noted that the “field-through” is a phenomenon in which, when a scanning signal is supplied to the scanning line 40, a potential is supplied to the pixel electrode 21 through the data line 50, and then when the supply of the scanning signal to the scanning line 40 is finished (for example, when the potential of the scanning line 40 lowers), the potential of the pixel electrode 21 changes due to a parasitic capacitance between the pixel electrode 21 and the scanning line 40 (for example, lowers along with the lowering of the potential of the scanning line 40). The common potential Vcom may be set to a value slightly lower than the reference potential GND, the high potential VH or the low potential VL, anticipating that the potential of the pixel electrode 21 would lower due to field-through. In this case also, the common potential Vcom is assumed to be the same potential as the reference potential GND, the high potential VH or the low potential VL.

The invention is not limited to the embodiments described above, and may be suitably modified within the range that does not depart from the subject matter and the idea of the invention readable from the scope of patent claims and the entire specification, and methods for controlling an electro-optical device, devices for controlling an electro-optical device, electro-optical devices and electronic apparatuses which include such modifications are deemed to be included in the technical scope of the invention.

The entire disclosure of Japanese Patent Application No. 2011-090929, filed Apr. 15, 2011 is expressly incorporated by reference herein.

What is claimed is:

1. A control method for controlling an electro-optical device equipped with a display section formed from a plurality of pixels each having an electro-optical substance between a pixel electrode and a counter electrode disposed opposite each other, and a drive section that applies voltage across the pixel electrode and the counter electrode of each of the plurality of pixels, the control method comprising:
when an image displayed at the display section is rewritten from a first image including a first section displayed in a first gray level and a second section displayed in a second gray level different from the first gray level to a second image including a third section displayed in the first gray level,
controlling the drive section such that
voltage corresponding to the first gray level is applied between the pixel electrode and the counter electrode of a first pixel, among the plurality of pixels, whose gray level to be displayed changes from the second gray level to the first gray level,
voltage corresponding to the first gray level is applied between the pixel electrode and the counter electrode of a second pixel having at least two sides adjacent to pixels displayed in the second gray level when the first image is displayed at the display section, among pixels whose gray level to be displayed does not change and remains in the first gray level among the plurality of pixels, and
voltage is not applied between the pixel electrode and the counter electrode of a third pixel other than the second pixel among the pixels whose gray level to be displayed does not change and remains in the first gray level among the plurality of pixels.

2. The control method according to claim 1,
wherein the second image includes a fourth section displayed in the second gray level, and
wherein the method further comprising:
controlling the drive section such that
voltage corresponding to the second gray level is applied between the pixel electrode and the counter electrode of a fourth pixel, among the plurality of pixels, whose gray level to be displayed changes from the first gray level to the second gray level, and
voltage is not applied between the pixel electrode and the counter electrode of a fifth pixel whose gray level to be displayed does not change and remains in the second gray level among the plurality of pixels.

3. A control device for controlling an electro-optical device equipped with a display section formed from a plurality of pixels each having an electro-optical substance between a pixel electrode and a counter electrode disposed opposite each other, and a drive section that applies voltage across the pixel electrode and the counter electrode of each of the plurality of pixels,
the control device controlling, when an image displayed at the display section is rewritten from a first image including a first section displayed in a first gray level and a second section displayed in a second gray level different from the first gray level to a second image including a third section displayed in the first gray level, the drive section such that
voltage corresponding to the first gray level is applied between the pixel electrode and the counter electrode of a first pixel, among the plurality of pixels, whose gray level to be displayed changes from the second gray level to the first gray level,
voltage corresponding to the first gray level is applied between the pixel electrode and the counter electrode of a second pixel having at least two sides adjacent to pixels displayed in the second gray level when the first image is displayed at the display section, among pixels whose gray level to be displayed does not change and remains in the first gray level among the plurality of pixels, and
voltage is not applied between the pixel electrode and the counter electrode of a third pixel other than the second pixel among the pixels whose gray level to be displayed does not change and remains in the first gray level among the plurality of pixels.

4. The control device according to claim 3,
wherein the second image includes a fourth section displayed in the second gray level, and
wherein the control device controls the drive section such that
voltage corresponding to the second gray level is applied between the pixel electrode and the counter electrode of a fourth pixel, among the plurality of pixels, whose gray level to be displayed changes from the first gray level to the second gray level, and
voltage is not applied between the pixel electrode and the counter electrode of a fifth pixel whose gray level to be displayed does not change and remains in the second gray level, among the plurality of pixels.

5. An electro-optical device comprising the control device for controlling an electro-optical device recited in claim 3.

6. An electro-optical device comprising the electro-optical device recited in claim 5.
